(19) United States
(12) Patent Application Publication
(10) Pub. No.: US 2007/0180366 A1
(43) Pub. Date: Aug. 2, 2007

(54) Recording medium for storing print document registration program and print document registration method

(76) Inventor: Tomonori Sato, Sagamihara-shi (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/405,727

(22) Filed: Apr. 17, 2006

(30) Foreign Application Priority Data
Jan. 31, 2006 (JP) 2006-022490

(51) Int. Cl. G06F 17/00; G06F 15/00

(52) U.S. Cl. 715/523

(57) ABSTRACT

A recording medium for storing a print document registration program executed by a computer as a user terminal, the print document registration program allowing the computer to function as: a selection unit for allowing a user to select a desired mail message from a displayed list of mail messages in a mail folder used by an electronic mail client program; a conversion unit for converting the mail message selected by the user into a file of which a form does not depend on the electronic mail client program; and a transmission unit for transmitting the converted mail message to a printing management server as an external device of the user terminal.

### BACKGROUND OF THE INVENTION

1. Field of the Invention

The present invention relates to a recording medium for storing a print document registration program.

2. Description of Related Art

In recent years, offices have been remotely located like satellites and have turned into small office home offices (SOHOs), and users of mobile instruments have been increased. Accordingly, there has been increased a demand for a printing system on the basis of a server, which is capable of performing printing without a driver from user terminals to a shared printer. In particular, there has been a request from user terminals without the driver that electronic mail be printed without the driver.

For example, a method is considered, which performs the printing by transmitting the document data from the user terminals to a virtual electronic mail address assigned to the printer by a server (for example, refer to Japanese Patent Application Publication No. 2005-521166). Specifically, such a print server converts the electronic mail transmitted from the user terminals into a printable format, and allows the printer corresponding to the virtual electronic mail address to print the electronic mail.

Moreover, there is a method in which an application service provider (ASP) server prints received electronic mail (including attached files) stored in a mail server according to instructions from the user terminals (for example, refer to Japanese Patent Laid-Open No. 2002-132679). Specifically, the electronic mail is transferred from the mail server to the ASP server according to a transfer instruction thereof from the user terminals to the mail server. The ASP server converts the electronic mail concerned into the printable format, and makes the printer as an output destination print the electronic mail according to the instructions from the user terminals to the ASP server.

Moreover, for the purpose of registering the electronic mail, which is received from the mail server, into the server from the user terminals without the driver, followed by the printing, there have been the following three methods.

A first method is to directly register the electronic mail from the user terminals, and to directly print the electronic mail from the mail server. Alternatively, the first method is to print the electronic mail converted into a PDF format or the like by a tool capable of portable document format (PDF) conversion in the mail server.

A second method is to once convert the electronic mail into a PDF file in each of the user terminals by using the PDF conversion tool, to register the electronic mail as PDF document data into the server, and to print the registered PDF document data from the server.

A third method is a method to activate an electronic mail client program in each of the user terminals, and to cut and paste a body portion of the mail by an operation of each user to convert the body portion into text, followed by the registration thereof into the server, and to print the text from the server.

However, in the above-described conventional method of assigning the electronic mail address to the printer, it has been necessary to assign and set the electronic mail address at the time when the system is installed. Accordingly, a cost burden of the system and a work load on a system installer have been large. Moreover, since a process for converting the electronic mail is performed, a processing load on the print server has been large.

Moreover, in the above-described conventional method in which the ASP server prints the electronic mail by receiving the electronic mail address, it has been necessary to issue a notice from the mail server to the user terminal, and to instruct from the user terminal to the mail server on the transfer of the received mail to the ASP server. Accordingly, it has been necessary for the user terminal to communicate also with the mail server in addition to the ASP server. Therefore, a procedure has become complicated, and a work load on the user has been large.

Furthermore, in the above-described conventional first method accompanied with the registration of the electronic mail, it has been necessary for the user to select a message to be registered in an electronic mail client before the registration of the electronic mail, and to store the message as an electronic mail document file (in an eml format or the like) per one message, thereby preparing the document data to be printed. Accordingly, the work load on the user has been large. Moreover, it has been necessary to introduce, into a printing management server, a tool for directly printing the electronic mail and a tool for converting the electronic mail into the PDF format, and cost of implementing the printing management server has been large.

Moreover, in the above-described conventional second method, it has been necessary to install the PDF conversion tool and the like on the user terminals. In addition, it has been necessary for the user to convert the electronic mail into the PDF format before the registration of the electronic mail. Therefore, the work load on the user has been large.

Furthermore, in the above-described conventional third method, it has been necessary for the user to perform work to activate the electronic mail client, and to cut and paste the body portion of the mail onto the application for registering the document, followed by the registration thereof. Accordingly, the work load on the user has been large.

### SUMMARY

The present invention has been made in consideration of the above-described points. It is an object of the present invention to make electronic mail printable in a user terminal without a driver, followed by registration thereof, and to reduce a work load on a user.

In order to achieve the above-described object, in accordance with an embodiment according to the first aspect of the present invention, a recording medium for storing a print document registration program executed by a computer as a user terminal, the print document registration program allowing the computer to function as:

a selection unit for displaying a list of mail messages in a mail folder to be used by an electronic mail client program, and allows a user to select a desired mail message;

a conversion unit for converting the mail message selected by the user into a file which does not depend on the electronic mail client program; and

a transmission unit for transmitting the converted mail message to a printing management server as an external device of the user terminal.

Preferably, the conversion unit converts the selected mail message into a text format.

Preferably, the conversion unit converts the selected mail message into a rich text format.

Preferably, the selection unit displays contents of the mail message of which preview is designated by the user before the mail message is transmitted by the transmission unit.

Preferably, the transmission unit associates an attached file of the selected mail message with the converted mail message, and transmits the associated attached file and mail message to the printing management server.

Preferably, the print document registration program operates on a web browser program.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a view showing a configuration of a printing system 1 according to an embodiment of the present invention;

FIG. 2 is a block diagram showing internal configurations of a user terminal 10, a printing management server 20, and a printing device 30;

FIG. 3 is a flowchart showing a print document registration process executed in the user terminal 10;

FIG. 4 is a view showing a login screen 51;

FIG. 5 is a view showing a mail client selection screen 52;

FIG. 6 is a view showing a mail message selection screen 53;

FIG. 7 is a view showing a mail message preview screen 54;

FIG. 8 is a view showing an attached file preview screen 55;

FIG. 9 is a view showing a configuration example of mail messages in a mail folder F1, an internal configuration example of the mail message M1, and a conversion example of the mail message M1;

FIG. 10 is a flowchart showing a printing process;

FIG. 11 is a view showing a login screen 61;

FIG. 12 is a view showing a mail message selection screen 62;

FIG. 13 is a view showing an attached file printing setting screen 63;

FIG. 14 is a warning screen 64; and

FIG. 15 is a block diagram showing internal configurations of a user terminal 10A, a printing management server 20A, and the printing device 30.

### DETAILED DESCRIPTION OF PREFERRED EMBODIMENTS

A description will be made below of embodiments of the present invention based on the drawings.

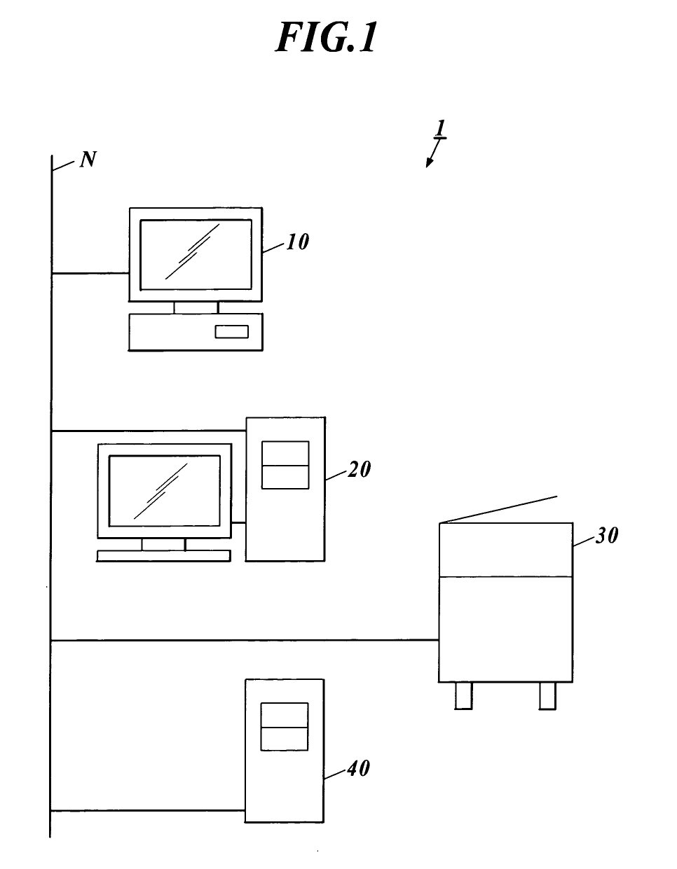

A description will be first made of a device configuration of a printing system 1 of this embodiment with reference to FIG. 1 to FIG. 5.

As shown in FIG. 1, the printing system 1 includes a user terminal 10, a printing management server 20, a printing device 30, and a mail server 40. The respective devices of the printing system 1 are connected in communication to one another through a communication network N.

Note that the mail server 40 manages electronic mail addressed to a user of at least one user terminal. In this configuration, the user terminal 10 is one which representatively expresses the respective user terminals, and the number of user terminals is not limited to one.

The printing system 1 is a system which registers, in the printing management server 20, electronic mail as a printing target among the electronic mail received to the address of the user of the user terminal 10, and prints data of the electronic mail concerned by the printing device 30.

The user terminal 10 receives the electronic mail through the mail server 40, and converts a mail message of the electronic mail as the printing target into printable document data and attached file, and transmits the converted mail message to the printing management server 20. The printing management server 20 registers the converted mail message received from the user terminal 10. Moreover, the printing management server 20 transmits the mail message as the printing target to the printing device 30. The printing device 30 receives the mail message from the printing management server 20, and then prints the mail message concerned.

The mail server 40 manages the electronic mail received and transmitted between the user terminal 10 and instruments on the communication network N. For example, the mail server 40 stores electronic mail in which an external instrument is a transmission source and the user of the user terminal 10 is a transmission destination, and distributes the electronic mail to the user terminal 10. The communication network N is a network in the Internet, and may include a wide area network (WAN), a local area network (LAN), an intranet, and the like.

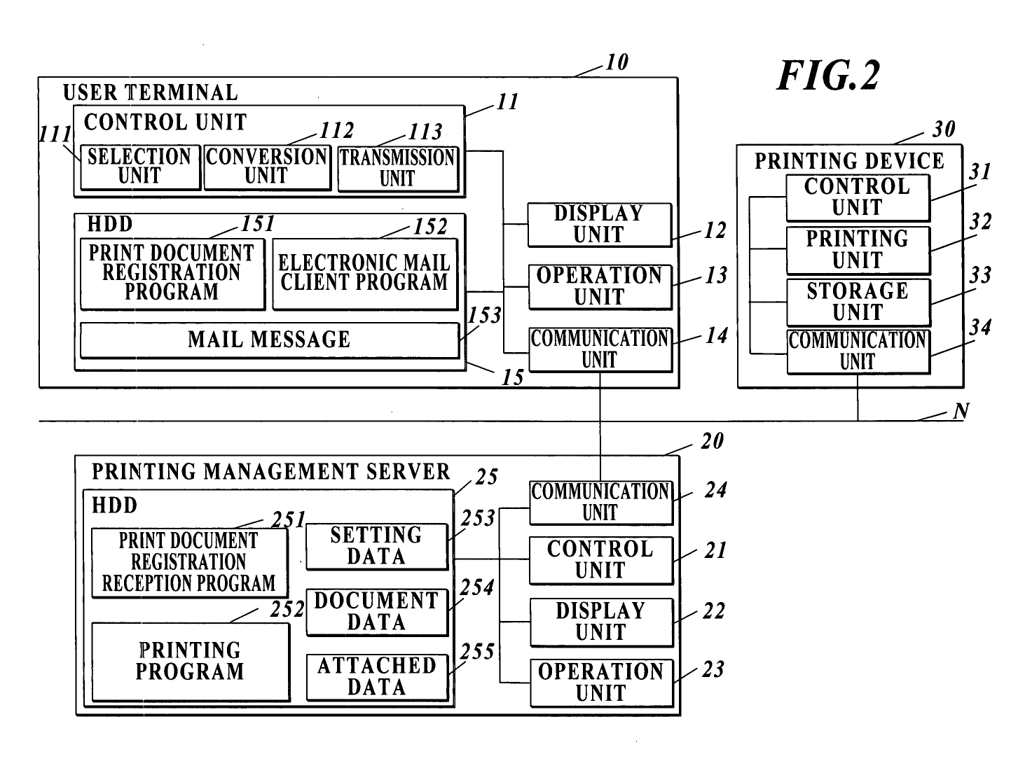

FIG. 2 shows internal configurations of the user terminal 10, the printing management server 20, and the printing device 30. As shown in FIG. 2, the user terminal 10 includes a control unit 11, a display unit 12, an operation unit 13, a communication unit 14, and a hard disk drive (HDD) 15 as a recording medium. Moreover, the respective units of the user terminal 10 are connected to one another through a bus.

The control unit 11 includes a central processing unit (CPU) and a random access memory (RAM), and controls the respective units of the user terminal 10. The CPU of the control unit 11 reads out a designated program among a system program and a variety of application programs, which are stored in the HDD 15, expands the designated program in the RAM, and executes a variety of processes in cooperation with the program expanded in the RAM.

The control unit 11 functions as a selection unit 111, a conversion unit 112, and a transmission unit 113 by a print document registration program 151 to be described later. The selection unit 111 allows the display unit 12 to display a mail message selection screen, and selects the mail message to be printed based on a selection input of the mail message from the user through the operation unit 13. The conversion unit 112 converts a body portion of the mail message selected by the selection unit 111 into a format such as a text format, which is printable by the printing management server 20. The transmission unit 113 associates the attached file and the document data including the body portion converted by the conversion unit 112 with each other, and transmits the associated document data and attached file to the printing management server 20.

The display unit 12 is composed of a cathode ray tube (CRT) display, a liquid crystal display (LCD), or the like, and displays a screen in accordance with a display signal of the control unit 11.

The operation unit 13 includes a keyboard including cursor keys, numeric input keys, a variety of function keys, and the like, and outputs, to the control unit 11, a depression signal obtained in such a manner that the user depresses a certain key on the keyboard. Moreover, the operation unit 13 may include a pointing device such as a mouse, and may be configured to be capable of inputting positional information thereby.

The communication unit 14 is composed of a modem, a router, a network card, and the like, and relays the transfer of the information among the respective instruments on the communication network N.

The HDD 15 includes a magnetic information recording medium, and stores the variety of programs and a variety of data for use in the programs so as to be readable and writable. The HDD 15 stores the print document registration program 151, an electronic mail client program 152, and a mail message 153.

The print document registration program 151 is a program for performing a print document registration process to be described later. The electronic mail client program 152 is an application program for transmitting/receiving the electronic mail through the mail server 40 and managing the electronic mail concerned. The electronic mail client program 152 may include plural kinds of electronic mail client programs.

The mail message 153 is electronic mail data received from the mail server 40 or to be transmitted to the mail server 40, and has a data format for the electronic mail client program 152. The respective mail messages of the mail message 153 are stored in the respective mail folders partitioned for each of the electronic mail client programs and for an out-box, an in-box, and the like. For example, when the electronic mail client program is the Outlook Express, the mail messages in the in-box, the out-box, and the like are stored in message folder files (files such as the “in-tray.dbx” and the “out-tray.dbx” in a specific directory.

Moreover, the mail message 153 at least includes document data as a letter portion, and may include one having the attached file in addition to the document data concerned. The document data includes a header portion (including a transmission date, a sender's name, a destination, a copy destination, a subject name, a transfer destination, a definition portion, and the like) of the electronic mail, and the body portion. The attached file is an image file, a file for the variety of applications, a document file, or the like, and is not limited to a file of a specific format.

As shown in FIG. 2, the printing management server 20 includes a control unit 21, a display unit 22, an operation unit 23, a communication unit 24, and an HDD 25. Moreover, the respective units of the printing management server 20 are connected to one another through a bus.

The control unit 21 includes a CPU and a RAM, and controls the respective units of the printing management server 20. The control unit 21 executes a printing process to be described later based on a printing program 252.

The display unit 22, the operation unit 23, and the communication unit 24 are similar to the display unit 12, operation unit 13, and communication unit 14 of the user terminal 10, respectively.

The HDD 25 stores a variety of programs and a variety of data so as to be readable and writable. The HDD 25 stores a print document registration reception program 251, a printing program 252, setting data 253, document data 254, and an attached file 255.

The print document registration reception program 251 is a program for performing a print document registration reception process to be described later. The printing program 252 is a program for performing the printing process to be described later.

The setting data 253 is a variety of setting data including information which associates the document data and attached file of the same mail message, which are stored in the document data 254 and the attached file 255, with each other. The document data 254 is the document data of the mail message converted and received by the user terminal 10. The attached file 255 is the attached file of the mail message converted and received by the user terminal 10.

As shown in FIG. 2, the printing device 30 includes a control unit 31, a printing unit 32, a storage unit 33, and a communication unit 34. Moreover, the respective units of the printing device 30 are connected to one another through a bus.

The control unit 31 includes a CPU and a RAM, and controls the respective units of the printing device 30. The control device 31 allows the printing unit 32 to print the document data 254 and the attached file 255 which are received in the same way under a printing condition of the setting data 253 received from the printing management server 20.

The printing unit 32 prints the data as the printing target on a recording medium such as a recording sheet. The printing unit 32 performs the printing by a printing method such as an electrophotographic method, an inkjet method, and a thermal transfer method.

The storage unit 33 is composed of a RAM which temporarily stores the information, a flash memory capable of reading and writing the information, and the like. In the storage unit 33, printing data received from the printing management server 20 is temporarily stored.

The communication unit 34 is similar to the communication unit 14 of the user terminal 10. Moreover, the printing unit 30 may also be composed to include an operation unit, a display unit, or a touch panel having functions of both thereof.

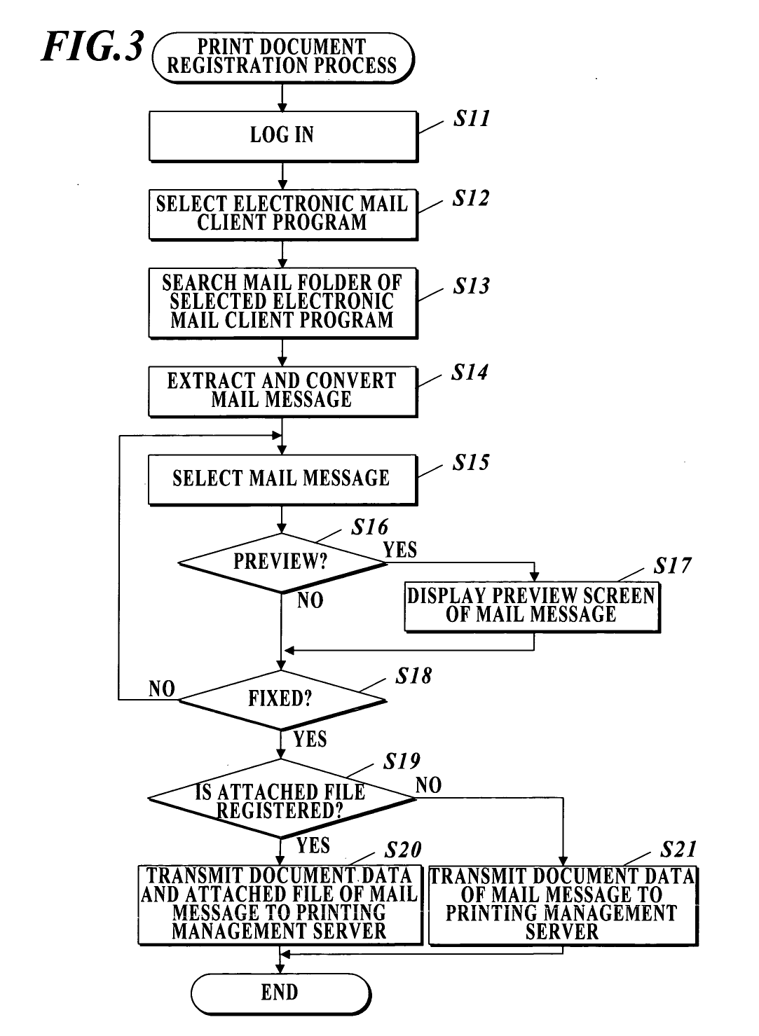

Next, a description will be first made of an operation of the printing system 1 with reference to FIG. 3 to FIG. 14. FIG. 3 shows a flow of the print document registration process executed in the user terminal 10. First, a description will be made of the print document registration process executed in the user terminal 10.

It is assumed that the mail message 153 is stored in the HDD 15 of the user terminal 10 in advance. In the user terminal 10, the print document registration program 151 is read out and activated by the control unit 11 when an execution instruction of the print document registration process is inputted as a trigger through the operation unit 13, and the print document registration process is executed.

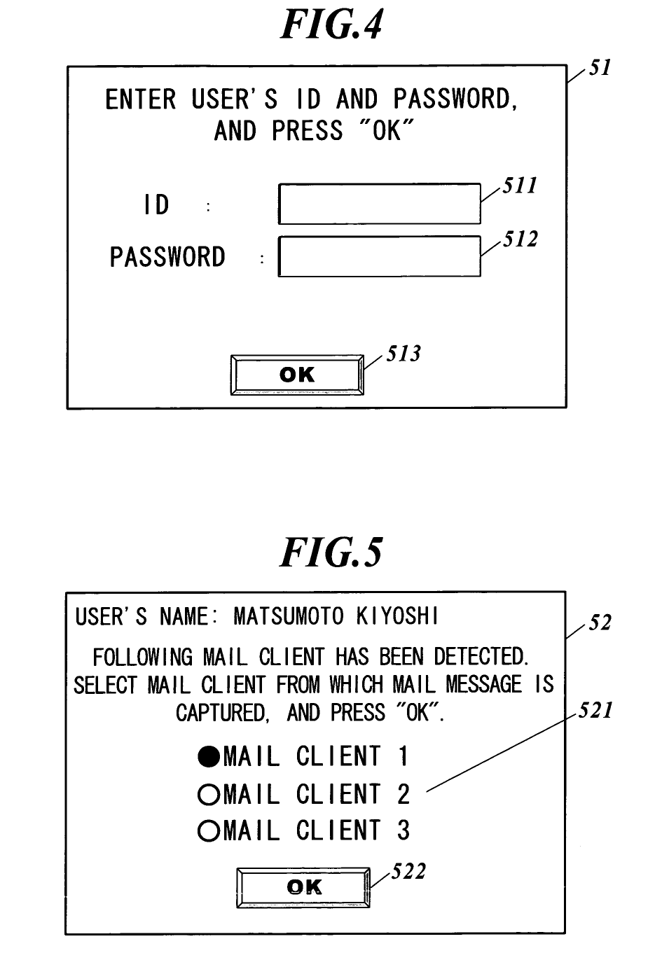

As shown in FIG. 3, a login process for the user is performed (Step S11). FIG. 4 shows a login screen 51. In the login process, for example, as shown in FIG. 4, the login screen 51 is displayed on the display unit 12. The login screen 51 includes an ID input column 511, a password input column 512, and an OK button 513. On the login screen 51, user's ID and password are entered through the operation unit 13 to the ID input column 511 and the password input column 512, respectively, and the OK button 513 is depressed. A user authentication is performed by the control unit 11 based on the entered ID and password, and when the user is authenticated, the user concerned is logged in.

Here, a configuration is adopted, in which the user authentication is performed by entering the ID and the password. However, a biometric authentication of a fingerprint, a face, an iris, and the like may be performed, and the like, or a configuration may be adopted, in which two or more authentication methods are combined.

Then, a mail client selection screen is displayed on the display unit 12, and a selection input of an electronic mail client program for use among electronic mail client programs in the electronic mail client program 152 is received (Step S12). FIG. 5 shows a mail client selection screen 52. For example, when three kinds of electronic mail clients are included in the electronic mail client program 152, the mail client selection screen 52 as shown in FIG. 5 is displayed on the display unit 12. The mail client selection screen 52 includes mail client selection marks 521 and an OK button 522. Then, the mail client for use is selectively entered through the operation unit 13 by the mail client selection marks 521. Moreover, the OK button 522 is depressed, and the selection of the electronic mail client program is thus ended.

Then, the mail folder corresponding to the electronic mail client program selected in Step S12 is searched and read out from the mail message 153 (Step S13). Then, the mail messages included in the mail folder searched in Step S13 are analyzed by the conversion unit 112, and the document data and the attached files are extracted from the mail messages concerned. Moreover, the bodies of the document data are converted into data of a format which does not depend on the electronic mail client program by the conversion unit 112 (Step S14).

In Step S14, the bodies of the document data in the mail message are converted into the data of the format which does not depend on the electronic mail client program, for example, such as a text data format and a rich text data format. Such a conversion format is a format in which the printing management server 20 has a printer driver (which enables the printing from the printing management server 20).

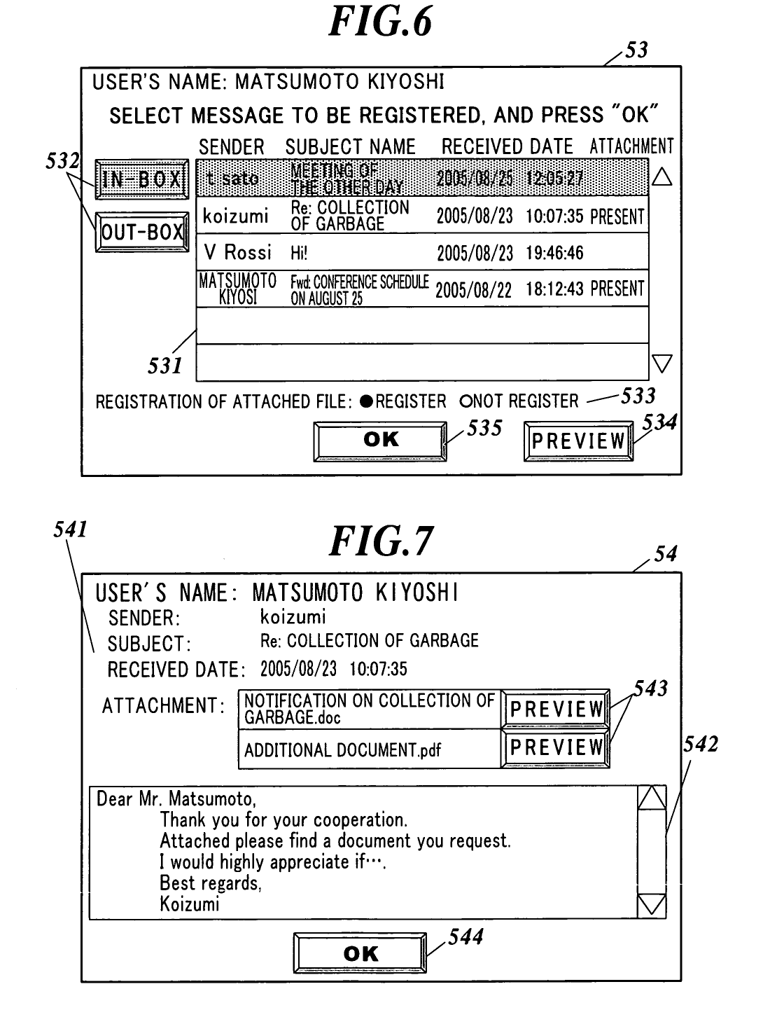

Then, the mail message selection screen is displayed on the display unit 12 by the selection unit 111, and the selection input of the mail message to be registered among the mail messages extracted in Step S14 is registered (Step S15). FIG. 6 shows a mail message selection screen 53. For example, when a certain electronic mail client is selected, the mail message selection screen 53 shown in FIG. 6 is displayed on the display unit 12 in order to select the mail message corresponding to the electronic mail client concerned. The mail message selection screen 53 includes a mail message display column 531, switching buttons 532, a preview button 534, and an OK button 535.

On the mail message selection screen 53, the respective mal messages are displayed in the mail message display column 531. The mail message to be registered is selected by the selection input of the mail message through the operation unit 13 by the user. Moreover, a storage destination of the mail messages displayed in the mail message display column 531 is switched between the out-box and the in-box by depressing the switching buttons 532. Moreover, whether or not the attached file is to be registered is set by a selection input of the selection mark 533.

Then, based on an instruction inputted through the selection unit 111 by the user, it is determined by the selection unit 111 whether or not the mail message under selection is to be previewed (Step S16). Specifically, it is determined whether or not such a preview is to be displayed depending on whether or not the preview button 534 is depressed through the operation unit 13 by the user on the mail message selection screen 53.

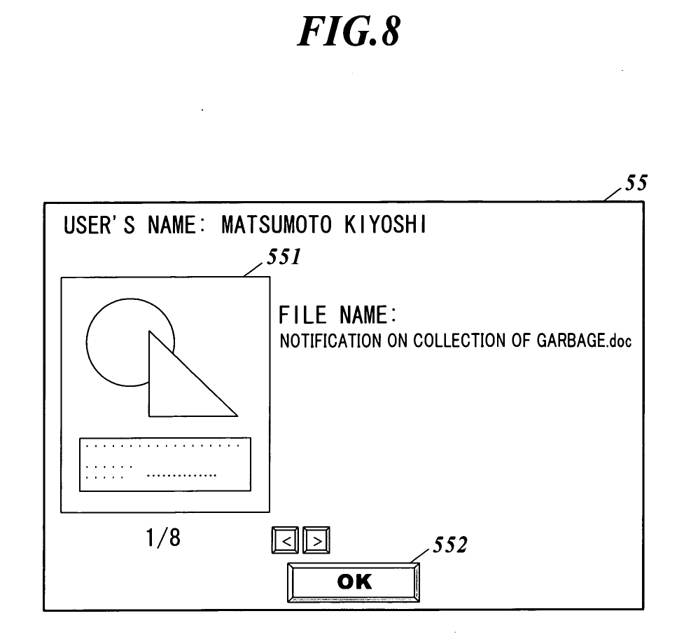

When the mail message under selection is previewed (YES in Step S16), the preview of the mail message under selection is displayed on the display unit 12 by the selection unit 111 (Step S17). FIG. 7 shows a mail message preview screen 54. FIG. 8 shows an attached file preview screen 55. Specifically, the mail message preview screen 54 shown in FIG. 7 is displayed on the display unit 12. The mail message preview screen 54 includes a header display portion 541, a body display column 542, preview buttons 543, and an OK button 544.

On the mail message preview screen 54, the sender's name and subject name of the mail message under selection are displayed in the header display portion 541, and the body contents of the mail message concerned are displayed in the body display column 542. Moreover, by depressing the preview button 543 through the operation unit 13 by the user, the attached file preview screen 55 shown in FIG. 8 is displayed on the display unit 12. Moreover, by depressing the OK button 544, the preview display is ended.

The attached file preview screen 55 includes an attached file display column 551 and an OK button 552. On the attached file preview screen 55, the attached file selected by the preview button 542 is displayed in the attached file display column 551. Moreover, by depressing the OK button 552 through the operation unit 13 by the user, the display returns to the display of the mail message preview screen 54.

Then, after the execution of Step S17 or when the mail message under selection is not previewed (NO in Step S16), it is determined whether or not the mail message under selection is to be fixed as a registration target (Step S18). Specifically, it is determined whether or not the selection of the mail message is to be fixed depending on whether or not the OK button 535 has been depressed through the operation unit 13 by the user on the mail message selection screen 53 shown in FIG. 6.

When the mail message to be registered is not fixed (NO in Step S18), the operation proceeds to Step S15. When the mail message to be registered is fixed (YES in Step S18), it is determined whether or not the attached file of the mail message to be registered is to be registered (Step S19). Specifically, it is determined whether or not the attached file is to be registered based on setting information on the selection mark 533 on the mail message selection screen 53 in FIG. 6.

When the attached file is registered (YES in Step S19), the converted document data and attached file which have been selected in Step S15 are associated with each other as the converted mail message by the transmission unit 113, and the mail message is transmitted thereby to the printing management server 20 through the communication unit 14 and the communication network N (Step S20). When the attached file is not registered (NO in Step S19), the converted mail message (only the converted document data) selected in Step S15 is transmitted by the transmission unit 113 to the printing management server 20 through the communication unit 14 and the communication network N (Step S21). After Step S20 or Step S21 is executed, the print document registration process is ended.

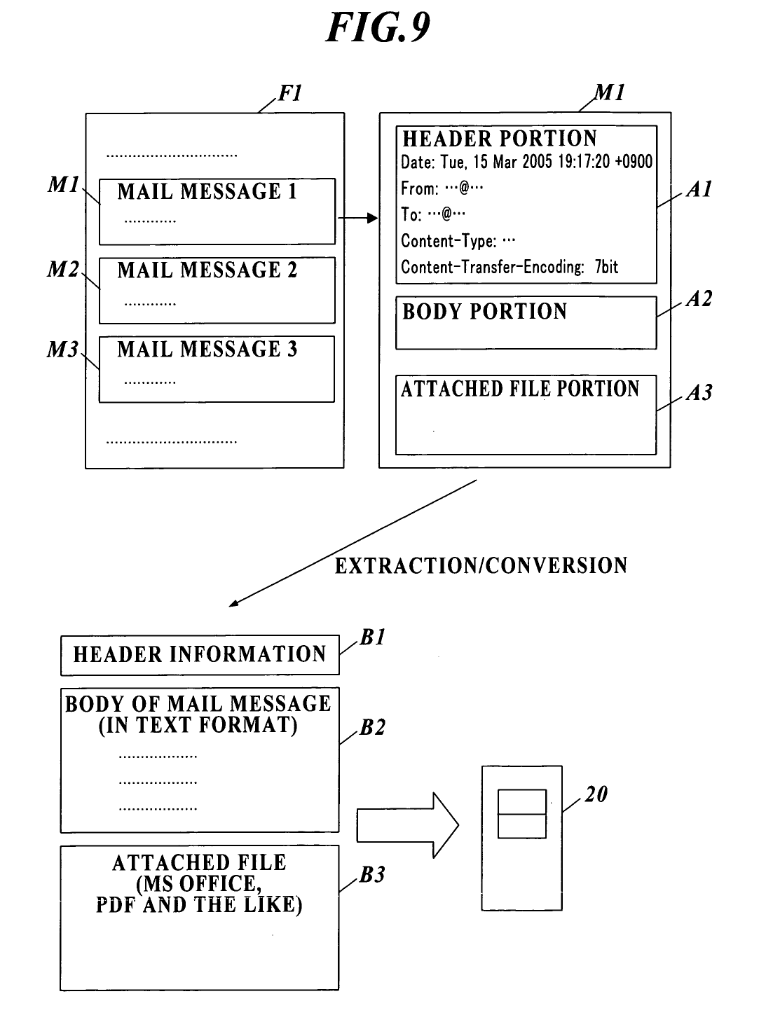

Here, a description will be made of the above-described print document registration process with reference to FIG. 9. FIG. 9 shows a configuration example of the mail messages in a mail folder F1, an internal configuration example of the mail message M1, and a conversion example of the mail message M1.

A case is considered, where, for example, as shown in FIG. 9, the mail folder F1 in the in-box corresponding to a predetermined electronic mail client program is selected in Step S13 of the print document registration process.

The mail folder F1 is composed in such a manner that the mail messages M1 to M3 are sequentially arrayed. In Step S15, the mail message M1 is selected. The mail folder F1 is composed by including a header portion A1 having the date (Date:), the transmission source (From:), the transmission destination (To:), a data type (Content-Type:), and the like, a body portion A2 of the mail body, and an attached file portion A3 encoded by, for example, the BASE64 format and the like.

In Step S14, the header portion A1, the body portion A2, and the attached file portion A3 are converted and extracted as header information B1, a body portion (of the text format) B2, and an attached file B3, respectively. For example, the document data of the mail message M1 is converted into plain text. The header information B1 is information necessary at the time of registration in the header portion A1. The body portion B2 is the body portion A2 converted into the text format and the like. Moreover, the attached file B3 is acquired in such a manner that a body portion of the attached file is extracted from the attached file portion A3 of the mail message M1, and for example, the BASE64 decoding and the like is carried out.

It is assumed that the header information B1, the body portion (of the text format) B2, and the attached file B3 are selected as the registration targets in Step S15. Then, in Step S20, the header information B1, the body portion (of the text format) B2, and the attached file B3 are transmitted to the printing management server 20.

In the example of FIG. 9, the Outlook Express is used as the electronic mail client program; however, the electronic mail client program is not limited to this. Even in other electronic mail client programs, the mail body and the attached file can be converted and extracted by using a substantially similar package.

The converted mail message (the converted document data and attached file) transmitted from the user terminal 10 in the print document registration process is received by the printing management server 20. In the printing management server 20, the control unit 21 executes the print document registration reception process based on the print document registration reception program 251.

The document data in the mail message received from the user terminal 10 through the communication unit 24 is stored in the document data 254 of the HDD 25, and in the same way, the attached file is stored in the attached file 255. Moreover, the document data and attached file of the same mail message are associated with each other, and information regarding such association is stored in the setting data 253. In such a way, the converted mail message is registered in the printing management server 20.

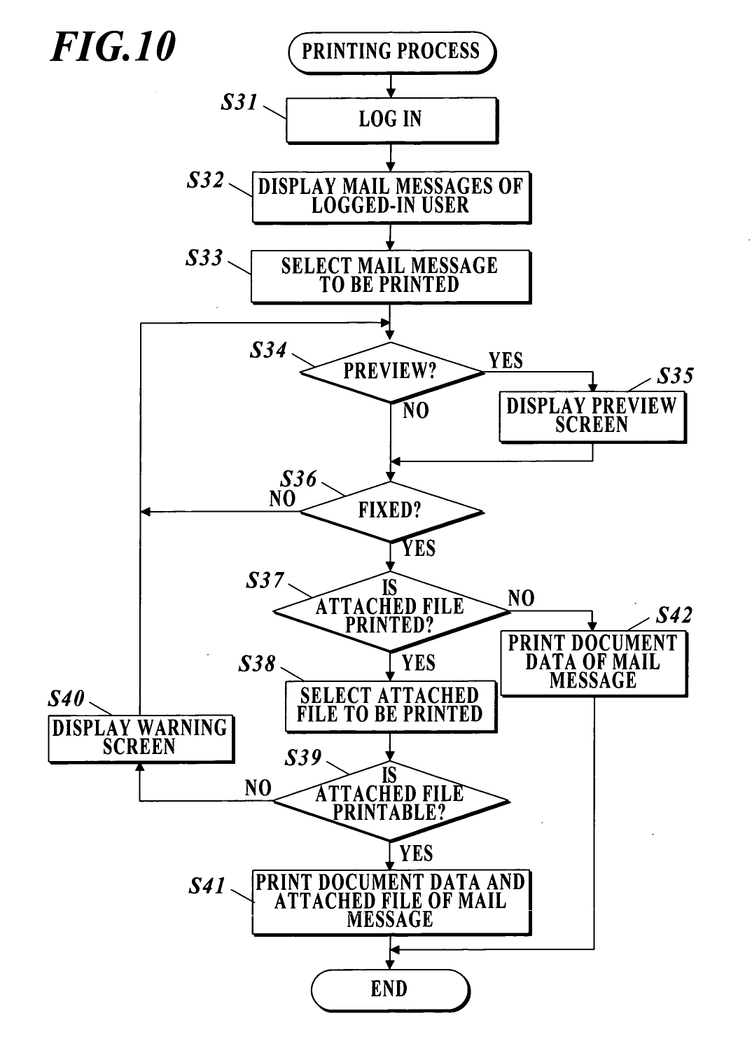

Subsequently, a description will be made of the printing process executed by the printing management server 20 with reference to FIG. 10 to FIG. 14. FIG. 10 shows a flow of the printing process.

It is defined that the mail message is registered in the printing management server 20 in advance. In the printing management server 20, the printing program 252 is read out and activated by the control unit 21 when an execution instruction of the printing process is inputted as a trigger through the operation unit 23, and the printing process is executed.

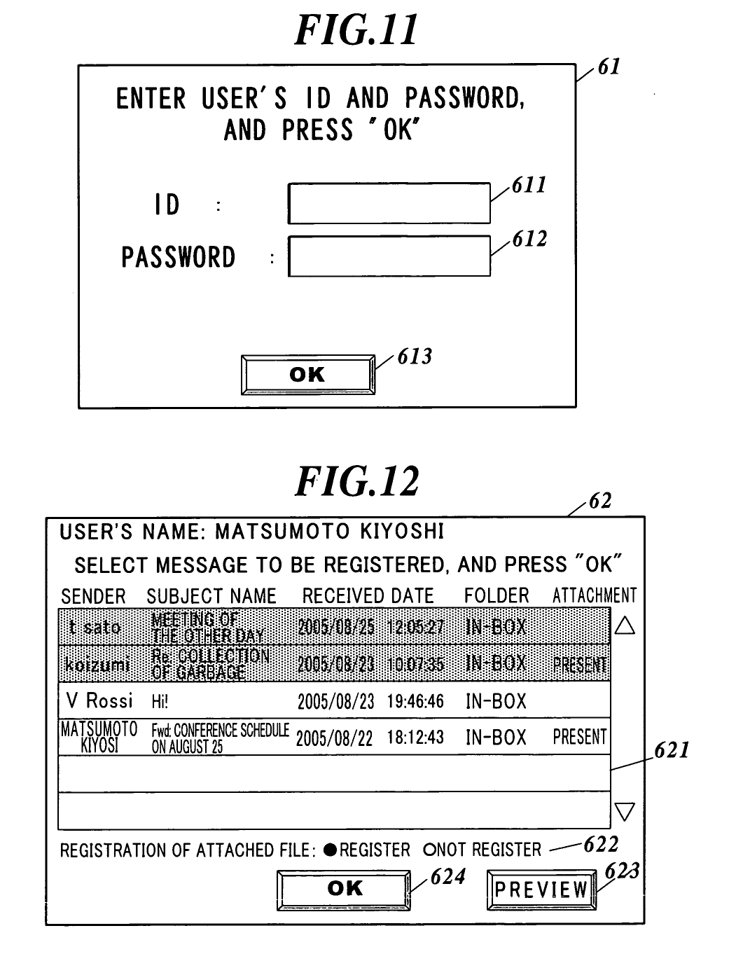

First, as shown in FIG. 10, a login process for the user is performed (Step S31). FIG. 11 shows a login screen 61. In the login process, for example, as shown in FIG. 11, the login screen 61 is displayed on the display unit 22. The login screen 61 includes an ID input column 611 and a password input column 612.

Then, the user's ID and password are entered through the operation unit 23 to the ID input column 611 and the password input column 612, respectively, and the OK button 613 is depressed. The user authentication is performed by the control unit 21 based on the entered ID and password, and when the user is authenticated, the user concerned is logged in. As in the login in the user terminal 10, the configuration is also adopted here, in which the user authentication is performed by entering the ID and the password; however, the biometric authentication of the fingerprint, the face, the iris, and the like may be performed, and the like, or the configuration may be adopted, in which two or more authentication methods are combined.

Then, the document data and attached files of the mail messages regarding the user logged in in Step S31 are read out from the document data 254 and the attached file 255, and the information indicating the mail messages concerned is displayed on the display unit 22 (Step S32). At this time, the setting data 253 is referred to, and based on the association information stored therein, the document data and the attached files are associated with each other. FIG. 12 shows a mail message selection screen 62. For example, in order to select the mail message corresponding to the logged-in user, the mail message selection screen 62 shown in FIG. 12 is displayed on the display unit 22.

Then, a selection input of the mail message to be printed among the mail messages extracted in Step S32 is received through the operation unit 13 (Step S33). On the mail message selection screen 62, the respective mail messages are displayed in the mail message display column 621. The mail message to be printed is selected by the selection input of the mail message through the operation unit 23 by the user.

Then, based on an instruction inputted through the operation unit 23 by the user, it is determined whether or not a preview of the mail message under selection is to be displayed (Step S34). Specifically, it is determined whether or not the preview is to be displayed depending on whether or not a preview button 623 is depressed through the operation unit 23 by the user on the mail message selection screen 62.

When the mail message under selection is previewed (YES in Step S34), a preview screen of the mail message under selection is displayed on the display unit 22 (Step S35). The preview screen thus displayed displays the preview of the header information, body portion, and attached file of the mail message, which is similar to the preview screen displayed on the user terminal 10.

After the execution of Step S35 or when the mail message under selection is not previewed (NO in Step S34), it is determined whether or not the mail message under selection is to be fixed as a printing target (Step S36). Specifically, it is determined whether or not the selection of the mail message is to be fixed depending on whether or not an OK button 624 has been depressed through the operation unit 13 by the user on the mail message selection screen 62 shown in FIG. 12.

When the mail message under selection is not fixed as the printing target (NO in Step S36), the operation proceeds to Step S34. When the mail message under selection is fixed as the printing target (YES in Step S36), based on an instruction inputted through the operation unit 23 by the user, it is determined whether or not the attached file of the mail message under selection is to be printed (Step S37). Specifically, it is determined whether or not the attached file is to be printed by a selection input of a selection mark 622 through the operation unit 23 by the user.

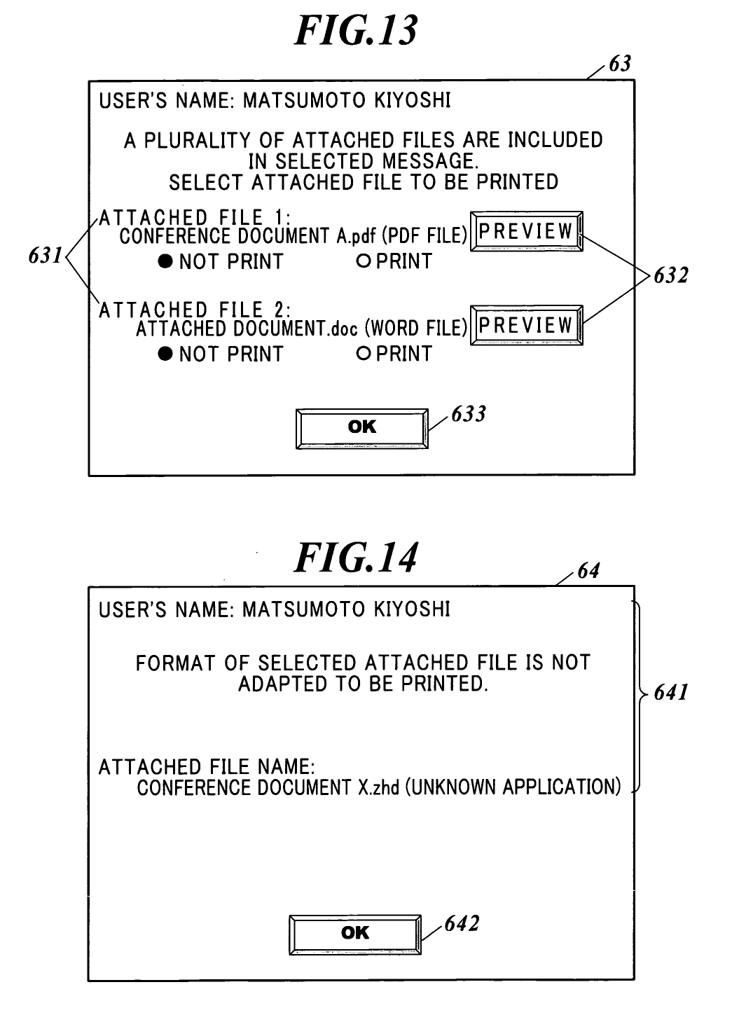

When the attached file of the mail message under selection is printed (YES in Step S37), the selection input of the attached file to be printed in the mail message under selection is received based on the instruction inputted through the operation unit 23 by the user (Step S38). FIG. 13 shows an attached file printing setting screen 63. For example, in order to selectively input the attached file to be printed, the attached file printing setting screen 63 shown in FIG. 13 is displayed on the display unit 22. The attached file printing setting screen 63 includes a display portion of the attached file names of the mail message under selection, selection marks 631, preview buttons 632, and an OK button 633.

On the attached file printing setting screen 63, the attached file to be printed is selected and set by a selection input of the selection mark 631 through the operation unit 23 from the user. Moreover, by depressing the preview button 632, the preview of the attached file is displayed on the display unit 22 as in Step S35. Then, by depressing the OK button 633, the selection of the attached file to be printed is ended.

Then, it is determined whether or not the attached file selected in Step S37 is printable (Step S39). Specifically, it is determined whether or not a printer driver program capable of printing the attached file is provided in the HDD 25.

When the selected attached file is not printable (NO in Step S39), a warning screen indicating that it is impossible to print the selected attached file is displayed on the display portion 22 (Step S40), and the operation proceeds to Step S34. FIG. 14 shows a warning screen 64. For example, the warning screen 64 shown in FIG. 14 is displayed on the display portion 22. The warning screen 64 includes a message display portion 641 and an OK button 642.

The message display portion 641 has display of the attached file name and to the effect that the attached file concerned cannot be printed. By depressing the OK button 642 through the operation unit 23 from the user, the display of the warning screen 64 is ended.

When the selected attached file is printable (YES in Step S39), the document data and attached file of the mail message are associated with each other, and are transmitted to the printing device 30 through the communication unit 24 and the communication network N (Step S41).

After the execution of Step S41, in the printing device 30, the document data and the attached file are received by the control unit 31 from the printing management server 20 through the communication unit 34, and are converted into actual printing data thereby. The actual printing data is printed in the printing unit 32 by the control of the control unit 31 based on the printing condition of the received setting data.

When the attached file of the mail message under selection is not printed (NO in Step S36), the document data of the mail message is transmitted to the printing device 30 through the communication unit 24 and the communication network N (Step S42). After the execution of Step S42, in the printing device 30, the document data is received by the control unit 31 from the printing management server 20 through the communication unit 34, and is converted into the actual printing data thereby. The actual printing data is printed in the printing unit 32 by the control of the control unit 31 based on the printing condition of the received setting data. After the execution of Step S41 or Step S42, the printing process is ended.

Note that, though not shown, the printing condition is set as appropriate by an input through the operation unit 23 in the printing management server 20. Information regarding the printing condition is transmitted together with the data of the mail message from the printing management server 20 to the printing device 30. The control unit 31 of the printing device 30 prints the mail message based on the received printing condition.

As described above, according to this embodiment, in the user terminal 10 without the driver, the mail message is converted into the printable format and transmitted to the printing management server 20, and then the printing management server 20 is allowed to register and print the mail message. Accordingly, the electronic mail can be converted to be easily printable, and can be registered and printed. Moreover, work such as cut and paste, which follows the printing of the message by the user, is not necessary, and a work load on the user can be reduced.

Moreover, the printing management server 20 can convert the body portion of the mail message into the printable text format and rich text format, and can register and print the body portion concerned. Accordingly, the printing management server 20 can register and print the mail message of the electronic mail without depending on the electronic mail client program.

Furthermore, it is not necessary to install the electronic mail client program and a tool for printing the electronic mail message file in the printing management server 20. Accordingly, cost of implementing the printing management server 20 can be reduced.

Moreover, in the print document registration process, the preview of the mail message is displayed in response to the request input from the user before the mail message is converted. Accordingly, the user can visually confirm the contents of the mail message before the mail message is transmitted.

Furthermore, the attached file of the mail message can be registered so as to be printable in association with the document data and can be printed. Moreover, in the printing process, the preview of the attached file of the mail message can be displayed in response to the request input from the user before the mail message is printed. Accordingly, the user can visually confirm the contents of the attached file before the conversion thereof.

### MODIFICATION EXAMPLE

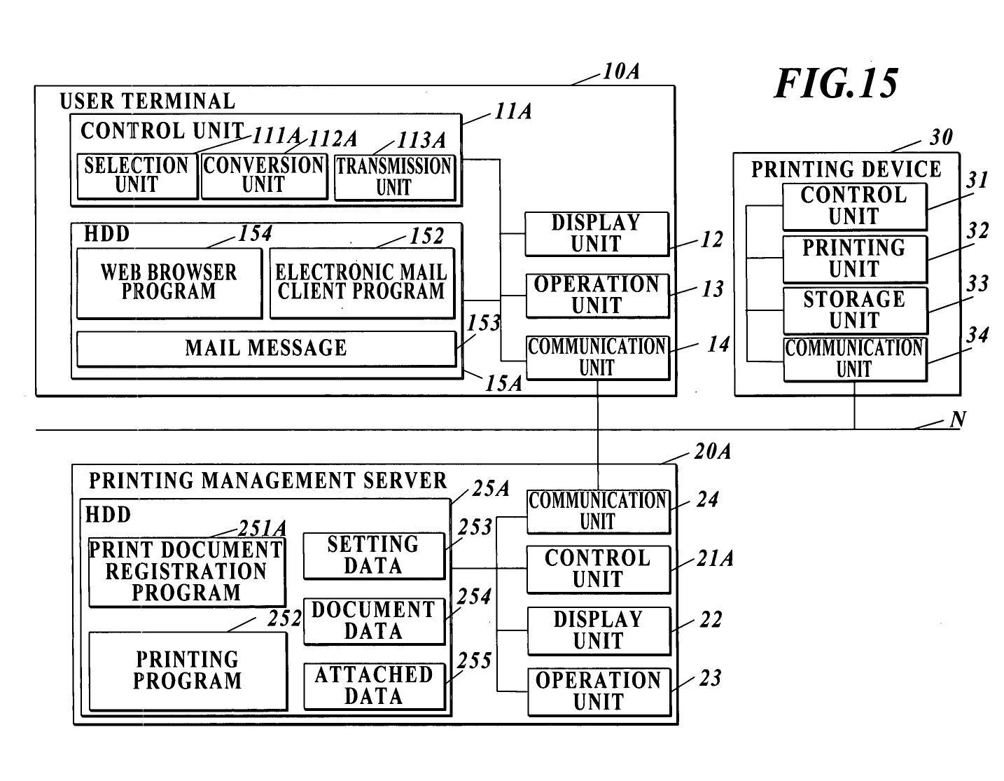

A description will be made of a modification example of the above-described embodiment with reference to FIG. 15. FIG. 15 shows internal configurations of a user terminal 10A, a printing management server 20A, and the printing device 30. In this modification example, a description will be mainly made of portions different from those of the above-described embodiment. Moreover, in the device configuration, the same reference numerals are assigned to the same portions as those of the above-described embodiment.

The printing system of this modification example includes the user terminal 10A, the printing management server 20A, and the mail server 40. The user terminal 10A has a browsing function. The printing management server 20A functions as a web server, and offers a print document registration function to the user terminal 10A based on an access for browsing from the user terminal 10A.

The user terminal 10A includes a control unit 11A and an HDD 15A in place of the control unit 11 and HDD 15 of the user terminal 10. In the execution of the print document registration process, the control unit 11A functions as a selection unit 111A, a conversion unit 112A, and a transmission unit 113A. The print document registration process is executed on a web browser program 154 under activation. The selection unit 111A, the conversion unit 112A, and the transmission unit 113A have similar functions to those of the selection unit 111, the conversion unit 112, and the transmission unit 113.

The HDD 15A stores the electronic mail client program 152, a web browser program 154, and the mail message 153. The web browser program 154 is a program for activating a program for allowing the user to browse a web page.

The printing management server 20A includes a control unit 21A and an HDD 25A as a recording medium in place of the control unit 21 and HDD 25 of the printing management server 20. The HDD 25A stores a print document registration program 251A, the printing program 252, the setting date 253, the document data 254, and the attached file 255. The print document registration program 251A is a program for offering the function of the print document registration process of the above-described embodiment, and further, for executing the print document registration reception process of the above-described embodiment.

The control unit 21A offers a similar function to that of the print document registration process of the above-described embodiment to the user terminal 10 based on the print document registration program 251A. Specifically, in response to the access (for the browsing) from the user terminal 10, which is made by the activation of the web browser program 154 in the user terminal 10, the control unit 21A allows the control unit 11A of the user terminal 10 to function as the selection unit 111A, the conversion unit 112A, the transmission unit 113, and the like. By this process, as in the print document registration process of the above-described embodiment, the user terminal 10 converts the mail message to be registered, associates the document data and attached file thereof with each other, and transmits the associated document data and attached file to the printing management server 20.

Moreover, the control unit 21A executes the print document registration reception process based on the print document registration program 251A. By this process, as in the print document registration reception process of the above-described embodiment, the printing management server 20 associates the document data and the attached file, which are received from the user terminal 10, with each other, and stores and registers the document data and the attached file in the setting data 253, document data 254, and attached file 255 of the HDD 25A.

In the user terminal 10, the variety of inputs regarding the print document registration process are received onto a browser screen displayed on the display unit 12.

According to this modification example, as in the above-described embodiment, it is not necessary to install the electronic mail client program and the tool for printing the electronic mail message file in the printing management server 20A. Accordingly, the printing management server 20A can be implemented at low cost. In addition to this, the user terminal 10A does not store the print document registration program. Accordingly, the user terminal 10A can be implemented at low cost.

Note that the descriptions in the embodiment and the modification example, which are described above, illustrate mere examples of the recording medium for storing the preferred print document registration program according to the present invention, and the recording medium is not limited to this.

For example, in the above-described modification example, a configuration is adopted, in which the printing management server 20A is set as the web server, the browsing function is provided to the user terminal 10A, and the input regarding the registration of the mail message (the document data and the attached file) is received on the browser screen displayed on the user terminal 10A; however, the configuration is not limited to this. For example, a configuration may be adopted, in which the variety of inputs regarding the printing of the mail message are also received on the browser screen displayed on the user terminal 10A.

Moreover, it is possible to appropriately modify detailed configurations and operations of the respective units constituting the printing system 1 in the embodiment and the modification example, which are described above, without departing from the gist of the present invention.

The present U.S. patent application claims the priority of Japanese Patent Application No. 2006-22490 filed on Jan. 31, 2006, according to the Paris Convention, and the above Japanese Patent Application is the basis for correcting mistranslation of the present U.S. patent application.

What is claimed is:

1. A recording medium for storing a print document registration program executed by a computer as a user terminal, the print document registration program allowing the computer to function as:
a selection unit for allowing a user to select a desired mail message from a displayed list of mail messages in a mail folder used by an electronic mail client program;
a conversion unit for converting the mail message selected by the user into a file of which a form does not depend on the electronic mail client program; and
a transmission unit for transmitting the converted mail message to a printing management server as an external device of the user terminal.

2. The recording medium of claim 1, wherein the conversion unit converts the selected mail message into a text format.

3. The recording medium of claim 1, wherein the conversion unit converts the selected mail message into a rich text format.

4. The recording medium of claim 1, wherein the selection unit displays contents of the mail message of which preview is designated by the user before the mail message is transmitted by the transmission unit.

5. The recording medium of claim 1, wherein the transmission unit associates an attached file of the selected mail message with the converted mail message, and transmits the associated attached file and mail message to the printing management server.

6. The recording medium of claim 1, wherein the print document registration program operates on a web browser program.

7. A print document registration method comprising:
displaying a list of mail messages in a mail folder used by an electronic mail client program;
selecting, based on a user selection, a desired mail message the list;
converting the selected mail message into a file of which a form does not depend on the electronic mail client program; and
transmitting the converted mail message to a printing management server as an external device of the user terminal.

8. The print document registration method of claim 7, wherein, in the converting step, the selected mail message is converted into a text format.

9. The print document registration method of claim 7, wherein, in the converting step, the selected mail message is converted into a rich text format.

10. The print document registration method of claim 7, wherein contents of the mail message of which preview is designated by the user is displayed in the selecting step before carrying out the transmitting step.

11. The print document registration method of claim 7, wherein, in the transmitting step, an attached file of the selected mail message is associated with the converted mail message, and the associated attached file and the converted mail message are transmitted to the printing management server.
